(19) United States
(12) Patent Application Publication
(10) Pub. No.: US 2019/0193633 A1
(43) Pub. Date: Jun. 27, 2019

(54) VIEWING DEVICE FOR VEHICLE

(71) Applicant: KABUSHIKI KAISHA TOKAI-RIKA-DENKI-SEISAKUSHO, Aichi (JP)

(72) Inventors: Tomonori ICHIKAWA, Aichi (JP); Toshinari NAKAI, Aichi (JP); Naoki SUNAGAWA, Aichi (JP); Masaki HAYASHI, Aichi (JP); Hiroki ISHIZUKA, Aichi (JP)

(21) Appl. No.: 16/099,089

(22) PCT Filed: Apr. 28, 2017
(86) PCT No.: PCT/JP2017/017087

§ 371 Date: Nov. 5, 2018

(30) Foreign Application Priority Data
May 11, 2016 (JP) 2016-095456

(51) Int. Cl. B60R 1/00; H04N 5/235; H04N 5/57; G06K 9/00

(52) U.S. Cl. CPC B60R 1/00; H04N 5/2353; H04N 5/57; G06K 9/00825; B60R 2300/8093; B60R 2300/105; B60R 2300/8066; B60R 2300/804; B60R 2300/8046

(57) ABSTRACT

A viewing device for a vehicle has: a rear lateral camera that captures images of a vehicle rear lateral side; a monitor that displays captured images of the rear lateral camera; and a control device that, in a case in which a monitor checking situation in which a vehicle periphery is dark is detected from vehicle information acquired from a vehicle ECU, controls the rear lateral camera so as to adjust exposure at a time of image capturing by the rear lateral camera such that captured images that are displayed on the monitor become brighter.

### TECHNICAL FIELD

The present invention relates to a viewing device for a vehicle that captures images of a vehicle periphery and displays the captured images, in order to view the vehicle periphery.

### BACKGROUND ART

Techniques have been proposed of, at an onboard display portion that is included in a navigation device or the like, adjusting the display luminance because the brightness of the display of the display portion interferes with the visibility of the driver of the vehicle if the display is too bright.

For example, Japanese Patent Application Laid-Open (JP-A) No. 2005-14782 proposes adjusting the brightness of the display of a display portion on the basis of the results of detection of the vehicle speed, as a technique used in cases in which there is no need to view the display at times of traveling at high speed.

### SUMMARY OF INVENTION

### Technical Problem

In JP-A No. 2005-14782, interference with the visibility of the driver due to the light of the display portion is suppressed by making the brightness of the display portion darker at times of traveling at high speed. However, there are situations in which the display portion is checked even at high speeds. In such cases, the display of the display portion is dark and hard to see, and therefore, there is room for improvement.

In particular, in cases of displaying captured images of the vehicle periphery on a display portion and checking the captured images instead of an optical mirror, at times such as when changing lanes while traveling at a high speed at night, or the like, the display portion is dark and the visibility of the vehicle periphery deteriorates.

The present invention was made in view of the above-described circumstances, and an object thereof is to provide a viewing device for a vehicle that can improve visibility in cases in which it is necessary to view the vehicle periphery.

### Solution to Problem

In order to achieve the above-described object, a first aspect of the present disclosure has: an imaging portion that captures images of a vehicle periphery; a display portion that displays captured images that are captured by the imaging portion; and an adjusting section that, in a case in which predetermined first vehicle information, which expresses a predetermined situation in which a vehicle occupant must check the display portion, is detected, or in a case in which a predetermined operation is detected by a detecting portion that detects the predetermined operation, adjusts at least one of exposure at a time of image capturing by the imaging portion or display luminance of the display portion, such that the captured images that are displayed on the display portion become brighter.

In accordance with the first aspect of the present disclosure, images of the vehicle periphery are captured at the imaging portion, and the captured images of the vehicle periphery that were captured by the imaging portion are displayed at the display portion.

At the adjusting section, in a case in which predetermined first vehicle information, which expresses a predetermined situation in which a vehicle occupant must check the display portion, is detected, or in a case in which a predetermined operation is detected by a detecting portion that detects the predetermined operation, at least one of the exposure at a time of image capturing by the imaging portion and the display luminance of the display portion is adjusted, such that the captured images that are displayed on the display portion become brighter.

The displayed images become brighter in a situation in which a vehicle occupant must check the display portion, or when instructed by a vehicle occupant. Therefore, the visibility in a case in which the vehicle periphery must be checked can be improved.

Note that, as in a second aspect of the present disclosure, in a case in which the first vehicle information is detected and predetermined second vehicle information that expresses that a vehicle periphery is dark is detected, or in a case in which the predetermined operation is detected, the adjusting section may adjust at least one of exposure at a time of image capturing by the imaging portion or display luminance of the display portion, such that the captured images that are displayed on the display portion become brighter. In this way as well, the visibility in a case in which the vehicle periphery must be checked can be improved.

As in a third aspect of the present disclosure, the second vehicle information can be lighting information of at least one of headlights and vehicle side lights. Because the headlights or the vehicle side lights are used when the vehicle periphery is dark, it can be detected that the vehicle periphery is dark from the lighting information.

Further, as in a fourth aspect of the present disclosure, the first vehicle information can be vehicle information expressing at least one situation of reversing, turning, a lane change, exiting of a vehicle occupant from the vehicle, or approach of an obstacle. In a situation such as reversing, turning, a lane change, exiting of a vehicle occupant from the vehicle, approach of an obstacle, or the like, there is the need to view the vehicle periphery. Therefore, a predetermined situation in which there is the need to check the display portion can be detected from vehicle information that expresses these.

Further, as in a fifth aspect of the present disclosure, the first vehicle information can be results of detection of a sightline detecting portion that detects that a vehicle occupant is gazing on the display portion for a predetermined time period or more. In a situation in which the vehicle occupant is gazing on the display portion for a predetermined time period or more, there is the possibility that the vehicle occupant must see the vehicle periphery. Therefore, a predetermined situation in which the display portion must be checked can be detected from the results of detection of the sightline detecting portion.

Further, as in a sixth aspect of the present disclosure, in a case in which the first vehicle information is detected, or in a case in which the predetermined operation is detected, the adjusting section may adjust at least one of the exposure and the display luminance such that the captured images that are displayed on the display portion become brighter from a predetermined brightness that corresponds to the naked eye. Due thereto, at usual times, the brightness of the captured images that are displayed on the display portion corresponds to the naked eye. Therefore, in a case in which there is no need to check the display portion, the vehicle occupant is not irritated by the brightness.

### Advantageous Effects of Invention

As described above, in accordance with the present invention, there is the effect of being able to provide a viewing device for a vehicle that can improve visibility in cases in which it is necessary to view the vehicle periphery.

### BRIEF DESCRIPTION OF DRAWINGS

FIG. 1A is a drawing showing an example of the installed position, in a vehicle, of a viewing device for a vehicle relating to an embodiment of the present invention.

FIG. 1B is a drawing showing the schematic structure of the viewing device for a vehicle relating to the embodiment of the present invention.

FIG. 2 is a block drawing showing the structure of a control system of the viewing device for a vehicle relating to the present embodiment.

FIG. 3 is a drawing for explaining an image for viewing that is generated by cutting-out a partial image from a captured image.

FIG. 4A is a drawing showing an example of an image of a predetermined brightness corresponding to the naked eye.

FIG. 4B is a drawing showing an example of an image that is brighter than usual.

FIG. 5 is a flowchart showing an example of the flow of processings that are carried out at a control device of the viewing device for a vehicle relating to the present embodiment.

FIG. 6 is a flowchart showing a first modified example of the flow of processings that are carried out at the control device of the viewing device for a vehicle relating to the present embodiment.

FIG. 7 is a flowchart showing a second modified example of the flow of processings that are carried out at the control device of the viewing device for a vehicle relating to the present embodiment.

FIG. 8 is a drawing showing the structure of the control system of the viewing device for a vehicle of a modified example.

FIG. 9 is a flowchart showing an example of the flow of processings that are carried out at the control device of the viewing device for a vehicle of the modified example.

### DESCRIPTION OF EMBODIMENTS

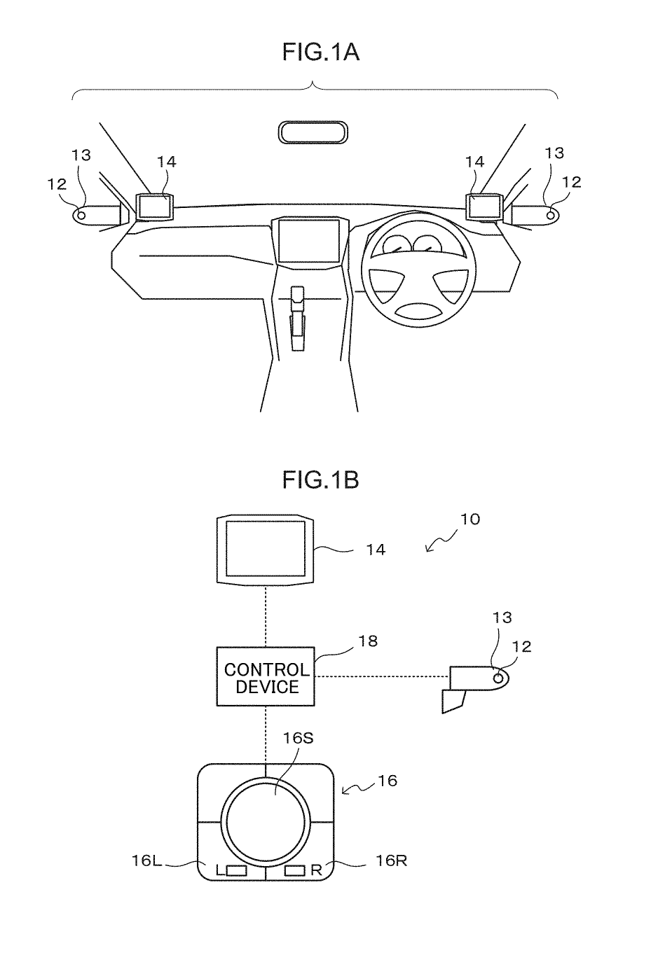

An example of an embodiment of the present invention is described in detail hereinafter with reference to the drawings. FIG. 1A is a drawing showing an example of the installed position, in a vehicle, of a viewing device for a vehicle relating to the present embodiment. FIG. 1B is a drawing showing the schematic structure of the viewing device for a vehicle.

A viewing device 10 for a vehicle relating to the present embodiment has rear lateral cameras 12 serving as imaging portions, monitors 14 serving as display portions, an operation portion 16, and control devices 18 serving as adjusting sections. The rear lateral cameras 12, the monitors 14 and the control devices 18 are provided in correspondence with the left and the right of the vehicle, respectively.

The rear lateral cameras 12 are disposed at the outer sides of the vehicle front side ends of the vertical direction intermediate portions of vehicle side doors (front side doors, not illustrated), and capture images of the vehicle rear lateral sides. The rear lateral camera 12 is provided at a housing 13 that is substantially shaped as a rectangular parallelepiped box and serves as a supporting body. The lens of the rear lateral camera 12 faces toward the vehicle rear lateral side, and captures images of the rear lateral side of the vehicle. The vehicle transverse direction inner side end portion of the housing 13 is mounted to the side door, and the housing 13 is supported at the side door (the vehicle body side) so as to be able to rotate in the vehicle longitudinal direction. Note that there may be a form in which the housing 13 is mounted to another position such as the front fender or the like, and not to the side door.

The monitor 14 is provided in a vicinity of the lower end of the front pillar, and mainly displays, as images for viewing, the captured images of the rear lateral camera 12. Namely, by using the monitor 14 in place of an outer mirror and checking the monitor 14, the vehicle rear lateral side that serves as the vehicle periphery can be viewed. The monitors 14 are provided in correspondence with the left and the right of the vehicle, respectively.

The operation portion 16 carries out instructions to change the display positions of the images displayed on the monitors 14, i.e., the viewing ranges of the rear lateral sides, and the like. The operation portion 16 has, for example, switches and sensors for carrying out instructing changing of the viewing range to the vehicle transverse direction, or instructing changing to the vehicle vertical direction, or the like, and switches for designating the monitor 14 (the left or the right) that is the object of the changing of the viewing range, and the like. Concretely, the operation portion 16 includes a left switch 16L and a right switch 16R for instructing the corresponding direction to the monitor 14 whose viewing range is to be changed, and a direction instructing portion 16S for designating the direction of the change.

The control devices 18 correspond to the left and right of the vehicle, respectively, and carry out display control of captured images 30 of the respective left and right rear lateral cameras 12. Note that the control devices 18 may further carry out reversing-interlocked control for changing the rear lateral viewing ranges at the time of reversing and making it easy to view obstacles that are at the lateral lower sides of the vehicle, and turning-interlocked control for changing a viewing range interlockingly with the operation of a turn signal and making it easy to view the vehicle rear lateral side, and the like.

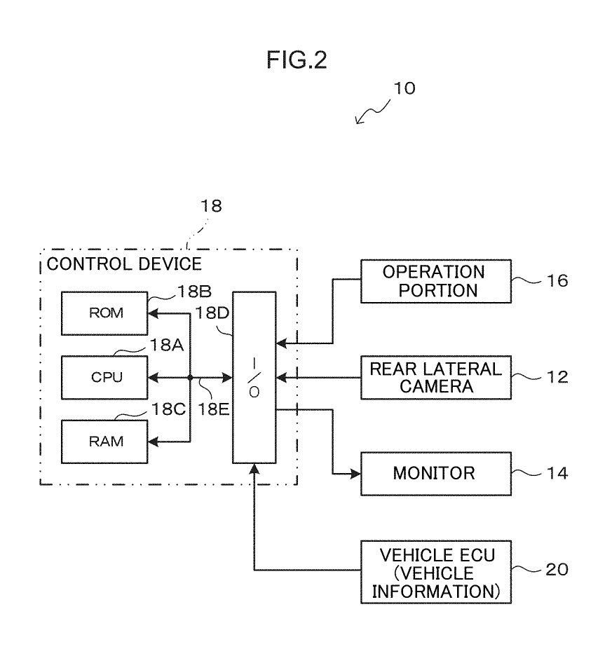

The structure of the control system of the viewing device 10 for a vehicle relating to the present embodiment is describe next. FIG. 2 is a block drawing showing the structure of the control system of the viewing device 10 for a vehicle relating to the present embodiment.

The control device 18 is structured by a microcomputer in which a CPU 18A, a ROM 18B, a RAM 18C, and an I/O (input/output interface) 18D are respectively connected to a bus 18E.

Various types of programs, such as a control program for the displaying of an image for viewing which is for displaying, on the monitor 14, the captured image 30 of the rear lateral side of the rear lateral camera 12, and the like are stored in the ROM 18D. Control of display on the monitor 14 is carried out by the program that is stored in the ROM 18B being expanded in the RAM 18C and executed by the CPU 18A.

The operation portion 16 for instructing changing of the viewing range and the like, the rear lateral camera 12, the monitor 14 and a vehicle ECU 20 are connected to the I/O 18D.

When an instruction to change the viewing range of the rear lateral side, or the like, is carried out by a vehicle occupant, the operation portion 16 outputs a change instruction signal to the control device 18. Concretely, the operation portion 16 has the above-described left switch 16L, right switch 16R and direction instructing portion 16S that are shown in FIG. 1B. Namely, the direction (left or right) corresponding to the monitor 14 whose viewing range is to be changed is instructed by the left switch 16L or the right switch 16R, and the direction in which the viewing range is to be changed (the vehicle transverse direction or the vehicle vertical direction) is instructed by the direction instructing portion 16S.

Due to the rear lateral camera 12 capturing an image of the vehicle rear lateral side, the captured image 30 of the rear lateral side is obtained. The captured image 30 of the rear lateral side that has been obtained by imaging is outputted to the control device 18 as results of image capturing of the rear lateral camera 12.

In accordance with the control of the control device 18, the monitor 14 displays the captured image 30 of the rear lateral side that has been captured by the rear lateral camera 12.

The vehicle ECU 20 detects, as vehicle information, signals of, for example, light switches, illumination sensors, a shift position sensor, a vehicle speed sensor, a steering angle sensor, turn lamp switches, an ignition switch (IG), obstacle detecting sensors of the vehicle lateral sides, and the like. Further, the vehicle ECU 20 outputs the detected vehicle information to the control devices 18. Note that the results of detection of the light switches and the illumination sensors correspond to second vehicle information that expresses that the vehicle periphery is dark. Further, the results of detection of the shift position sensor, the vehicle speed sensor, the steering angle sensor, the turn lamp switches, the ignition switch (IG) and the obstacle detecting sensors of the vehicle lateral sides correspond to first vehicle information that expresses a predetermined situation in which there is the need for a vehicle occupant to check the monitor 14.

On the basis of the results of image capturing of the rear lateral camera 12, the control device 18 carries out control of the display on the monitor 14, and, in a case in which a change in the viewing range of the rear lateral side is instructed by the operation portion 16, carries out control to change the display position of the monitor 14 (the viewing range of the rear lateral side). Further, in the present embodiment, the control device 18 has the function of adjusting the brightness of the image displayed on the monitor 14, on the basis of the vehicle information acquired from the vehicle ECU 20.

Note that the control device 18 may carry out display control of the left and right monitors 14 by the one control device 18, or the control devices 18 may be provided as a pair in correspondence with the left and the right of the vehicle. In a case in which a pair of the control devices 18 is provided in correspondence with the left and the right, the I/O 18D of each control device 18 may be connected to the other control device 18 so that communication therebetween is possible.

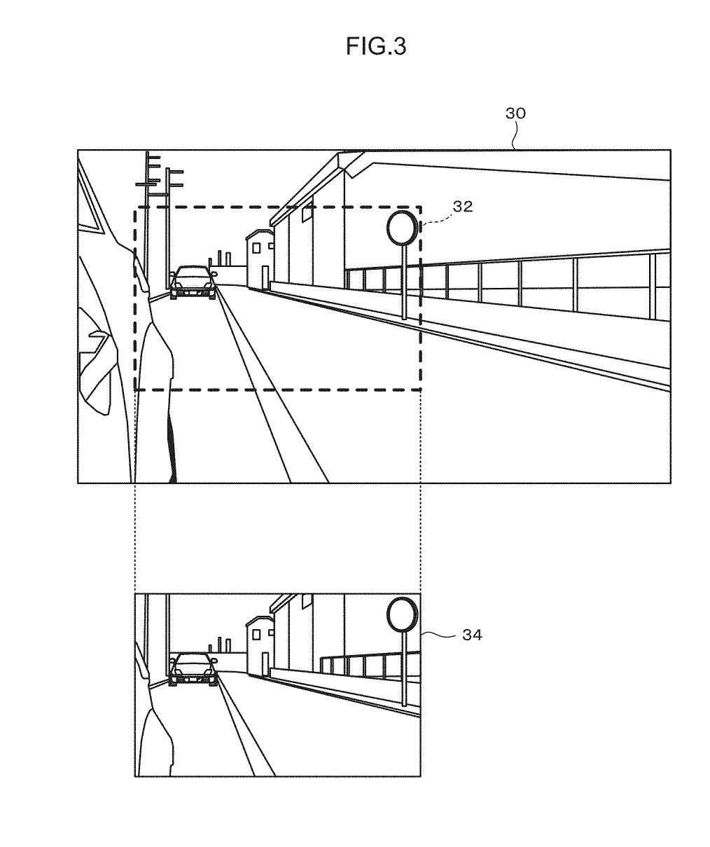

Here, the display method of the captured image 30 of the rear lateral camera 12 onto the monitor 14 by the control device 18 is described in detail. FIG. 3 is a drawing for explaining an image for viewing that is generated from the captured image 30.

At the viewing device 10 for a vehicle relating to the present embodiment, as shown in FIG. 3, the rear lateral side of the vehicle is imaged by the rear lateral camera 12, and a partial image 32 shown by the dotted line in FIG. 3 is cut-out from the captured image 30 obtained by the imaging. Then, the cut-out partial image 32 is displayed on the monitor 14 as image 34 for viewing. Namely, at the viewing device 10 for a vehicle relating to the present embodiment, because the partial image 32 that is a partial range of the captured image 30 is displayed, changing of the viewing range is made possible by changing the position of cutting-out. The changing of the viewing range is carried out by operating the operation portion 16. Concretely, the direction (the left or the right) at which the viewing range is to be changed is selected by operation of the left switch 16L or the right switch 16R, and the direction of changing the viewing range (the vehicle transverse direction or the vehicle vertical direction) is instructed by operation of the direction instructing portion 16S. Due thereto, the control device 18 changes the position of the partial image 32 that is to be cut-out, from the position of the current partial image 32 of the captured image 30 and in the direction operated by the operation portion 16, and displays the image 34 for viewing on the monitor 14. Namely, the image 34 for viewing that is displayed on the monitor 14 is displayed by being moved successively in the direction instructed by the direction instructing portion 16S.

Note that, because mirror-image conversion is carried out in order to display on the monitor 14 an image that is similar to that of an optical mirror, the captured image 30 in FIG. 3 is shown as an image that has been mirror-image converted in order to make the relationship between the partial image 32 at the captured image 30 and the image 34 for viewing easy to understand.

Further, the changing of the viewing range is not limited to a case of being instructed by the operation portion 16, and may be a case of establishment of a predetermined condition for carrying out, for example, the above-described reversing-interlocked control that changes the viewing ranges interlockingly with reversing, or turning-interlocked control that changes a viewing range interlockingly with turning. Here, a predetermined condition for carrying out reversing-interlocked control or turning-interlocked control is a condition that is determined in advance in accordance with, for example, the turn signals, the shift position, the vehicle speed or the like, and a known condition can be used therefore.

Further, the image 34 for viewing that is displayed on the monitor 14 may be a form in which the entire captured image 30, and not the partial image 32, is displayed and the viewing range is not changed. Therefore, in the following description, a form in which the entire captured image 30 is displayed on the monitor 14 is described in order to simplify explanation.

Adjustment, by the control device 18, of the brightness of the captured image that is displayed on the monitor 14 is described next.

With regard to the brightness of the captured image that is displayed on the monitor 14, at least one of the exposure at the time of imaging by the rear lateral camera 12 and the display luminance of the monitor 14 can be adjusted. For example, exposure adjustment at the time of imaging is possible by adjusting at least one of the exposure time, the shutter speed, the aperture and the gain at the time of image capturing by the rear lateral camera 12. Further, the display luminance can be adjusted by changing the brightness of the backlight, or the contrast.

In the present embodiment, instead of an optical mirror, by displaying the captured image of the vehicle rear lateral side on the monitor 14, it is possible to view the vehicle periphery. However, in a dark environment such as at night or the like, if the image that is displayed on the monitor 14 is bright, there are cases in which the vehicle occupant is irritated thereby.

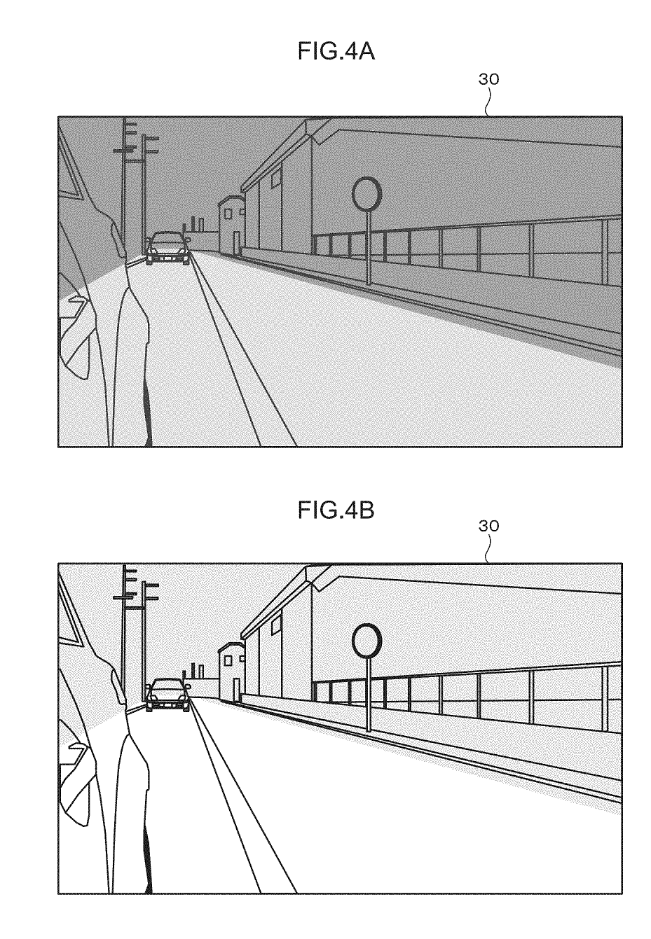

Thus, in the present embodiment, in a case in which a situation, in which the vehicle periphery is dark and the vehicle periphery must be seen, is detected, the control device 18 adjusts at least one of the exposure of the rear lateral camera 12 and the display luminance of the monitor 14 so that the image that is displayed on the monitor 14 becomes brighter. Namely, in a case in which a situation, in which the vehicle periphery is dark and the vehicle periphery must be seen, is detected, the visibility is improved by making the image that is displayed on the monitor 14 brighter than in a usual case, such as a case in which the vehicle periphery is bright or a case in which there is no need to view the vehicle periphery or the like. For example, in a usual case, there is an image of a predetermined brightness that corresponds to the naked eye as shown in FIG. 4A, and, in a case in which a situation, in which the vehicle periphery is dark and the vehicle periphery must be seen, is detected, adjustment is carried out such that the image becomes brighter than usual as shown in FIG. 4B. Due thereto, in a case in which the monitor 14 is checked and the vehicle periphery is viewed in an environment in which the vehicle periphery is dark, because the image becomes brighter, the visibility improves. On the other hand, in a usual case, there is an image of a brightness corresponding to the naked eye, and therefore, the vehicle occupant is not irritated by the brightness of the monitor 14.

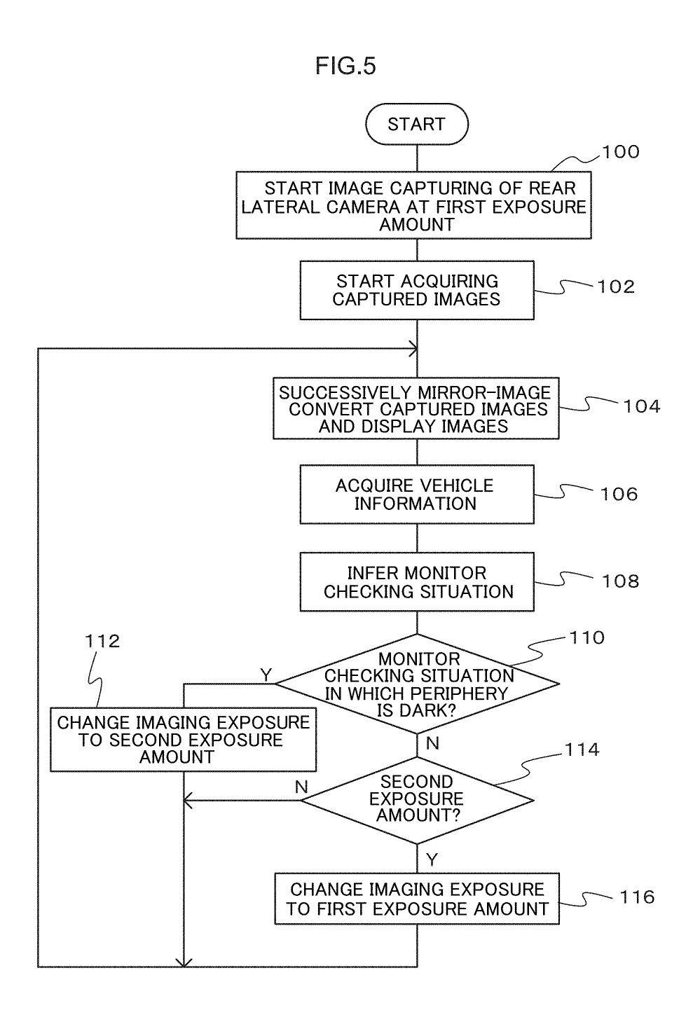

Concrete processings, which are carried out by the control device 18 of the viewing device 10 for a vehicle that relates to the present embodiment and is structured as described above, are described next. FIG. 5 is a flowchart showing an example of the flow of processings that are carried out at the control device 18 of the viewing device 10 for a vehicle relating to the present embodiment. Note that description is given in which the processings of FIG. 5 start in a case in which an unillustrated ignition switch is turned on. Further, the processings of FIG. 5 are carried out due to the CPU 18A expanding, in the RAM 18C, and executing the control program for the displaying of an image for viewing that is stored in the ROM 18B. Further, FIG. 5 describes an example in which the brightness of the image that is displayed on the monitor 14 is adjusted by adjusting the exposure at the time of image capturing by the rear lateral camera 12.

First, in step 100, the CPU 18A controls the rear lateral camera 12 such that image capturing of the rear lateral camera 12 is started at a first exposure amount, and moves on to step 102. The first exposure amount is a predetermined exposure amount that is such that the captured image that is displayed on the monitor 14 is a brightness corresponding to the naked eye, and at least one of the shutter speed, the aperture and the gain is adjusted.

In step 102, the CPU 18A starts successively acquiring the captured images of the rear lateral camera 12, and moves on to step 104.

In step 104, the CPU 18A successively mirror-image converts the acquired captured images, and controls the monitor 14 so as to display the images on the monitor 14, and moves on to step 106. Due thereto, captured images of the vehicle rear lateral side are displayed on the monitor 14 as if on an optical mirror, and therefore, the vehicle rear lateral side can be viewed as the vehicle periphery.

In step 106, the CPU 18A acquires various types of vehicle information from the vehicle ECU 20, and moves on to step 108. Signals of the light switches, the illumination sensors, the shift position sensor, the vehicle speed sensor, the steering angle sensor, the turn lamp switches, the ignition switch (IG), the obstacle detecting sensors of the vehicle lateral sides, and the like are acquired as the acquired vehicle information.

In step 108, the CPU 18A infers a monitor checking situation, and moves on to step 110. The inferring of a monitor checking situation here is the inferring of a situation in which the vehicle periphery is dark and the vehicle periphery must be viewed. For example, in a case in which a light switch is on, which corresponds to lighting information of at least one of the headlights or the vehicle side lights, or in a case in which illumination that is a predetermined illumination or lower is detected by an illumination sensor when an illumination sensor is provided, it is inferred that there is a situation in which the vehicle periphery is dark. Further, in a case in which reversing is detected by the shift position sensor, it is inferred that there is a situation of reversing in which the vehicle periphery must be checked. Further, from the results of detection of the vehicle speed sensor, the steering angle sensor and the turn lamp switches, it is inferred that there is a situation in which the vehicle periphery must be checked such as turning or a lane change or the like. Further, in a case in which it is detected that the ignition switch is off, it is inferred that there is a situation in which the vehicle occupant has exited the vehicle wherein there is no need to check the vehicle periphery. Further, from the results of detection of the obstacle detecting sensor of a vehicle lateral side, it is inferred that there is a situation of the approach of an obstacle from the vehicle lateral side wherein there is the need to check the vehicle periphery.

In step 110, the CPU 18A judges whether or not there is a monitor checking situation in which the periphery is dark. If this judgment is affirmative, the CPU 18A moves on to step 112, and, if this judgment is negative, the CPU 18A moves on to step 114.

In step 112, the CPU 18A controls the rear lateral camera 12 so as to change to a second exposure amount, at which there become images that are brighter than at the first exposure amount, and so as to capture images, and the CPU 18A returns to step 104 and repeats the above-described processings. Due thereto, in the case of a monitor checking situation in which the periphery is dark, the captured images that are are displayed on the monitor 14 become brighter, and the visibility in a situation in which the vehicle periphery is dark and the vehicle periphery must be checked can be improved. Note that the rear lateral camera 12 whose exposure amount is changed may be only one of the two left and right rear lateral cameras 12. Further, in a situation such as turning or a lane change or the approach of an obstacle or the like, it suffices to adjust the exposure of the rear lateral camera 12 of only the respectively corresponding direction.

On the other hand, in step 114, the CPU 18A judges whether or not the exposure amount of the rear lateral camera 12 is the second exposure amount. Namely, the CPU 18A judges whether or not there is a state in which the exposure amount was changed from the first exposure amount to the second exposure amount in step 112. If this judgment is affirmative, the CPU 18A moves on to step 116, and, if this judgment is negative, the CPU 18A returns to step 104 and repeats the above-described processings.

In step 116, the CPU 18A controls the rear lateral camera 12 so as to change to the first exposure amount and so as to capture images, and returns to step 104 and repeats the above-described processings.

By carrying out control in this way, in a situation in which the vehicle periphery is dark, such as at night or the like, and there is the need to check the vehicle periphery, the captured images that are displayed on the monitor 14 are brightened by adjusting the exposure at the time of image capturing, and therefore, the visibility improves and the safety can be improved.

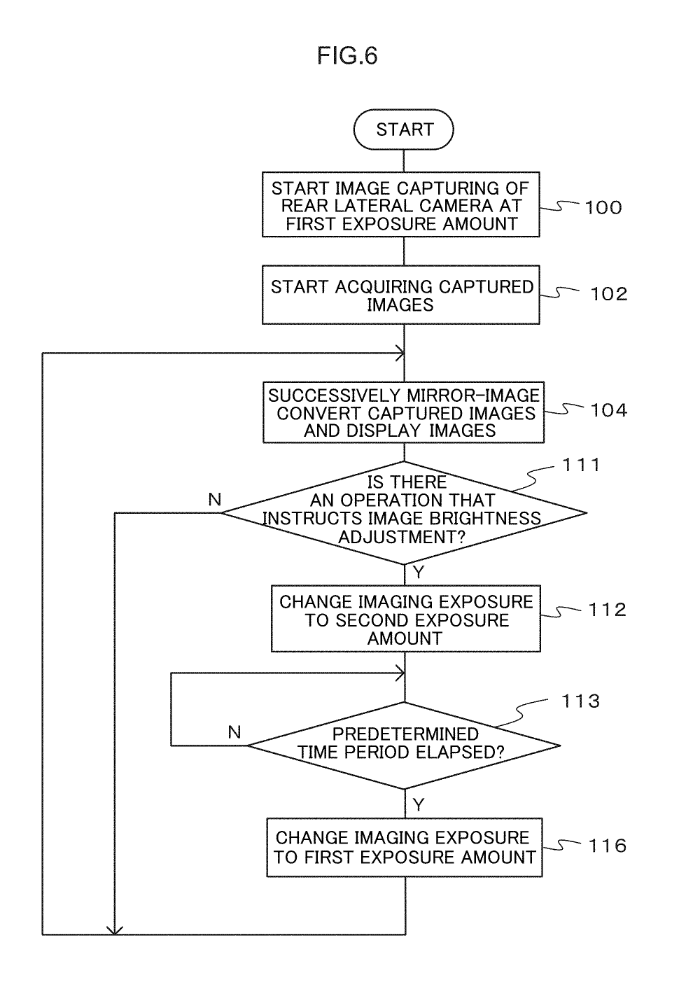

A first modified example of processings, which are carried out by the control device 18 of the viewing device 10 for a vehicle relating to the present embodiment, are described next. FIG. 6 is a flowchart showing a first modified example of the flow of processings that are carried out at the control device 18 of the viewing device 10 for a vehicle relating to the present embodiment. Note that description is given in which the processings of FIG. 6 start in a case in which an unillustrated ignition switch is turned on. Further, the processings of FIG. 6 are carried out due to the CPU 18A expanding, in the RAM 18C, and executing the control program for the displaying of an image for viewing that is stored in the ROM 18B. Further, FIG. 6 describes an example in which the brightness of the image that is displayed on the monitor 14 is adjusted by adjusting the exposure at the time of image capturing by the rear lateral camera 12. Further, processings that are the same as processings of FIG. 5 are described by using the same reference numbers.

First, in step 100, the CPU 18A controls the rear lateral camera 12 such that image capturing of the rear lateral camera 12 is started at a first exposure amount, and moves on to step 102. The first exposure amount is a predetermined exposure amount that is such that the captured image that is displayed on the monitor 14 is a brightness corresponding to the naked eye, and at least one of the shutter speed, the aperture and the gain is adjusted.

In step 102, the CPU 18A starts successively acquiring the captured images of the rear lateral camera 12, and moves on to step 104.

In step 104, the CPU 18A successively mirror-image converts the acquired captured images, and controls the monitor 14 so as to display the images on the monitor 14, and moves on to step 111. Due thereto, captured images of the vehicle rear lateral side are displayed on the monitor 14 as if on an optical mirror, and therefore, the vehicle rear lateral side can be viewed as the vehicle periphery.

In step 111, the CPU 18A judges whether or not an instruction operation to adjust the brightness of the image has been carried out. For example, the vehicle ECU 20 further detects the signal of a sensor or the like that detects an instruction operation, voice recognition, a gesture operation, the touch operation of a light switch, or the like that is to make the image brighter. In this judgment, it is judged whether or not a switch operation, voice input, a gesture operation, a touch operation of a light switch, or the like for giving an instruction to make the image brighter, has been carried out. If this judgment is affirmative, the CPU 18A moves on to step 112. If this judgment is negative, the CPU 18A returns to step 104 and repeats the above-described processings. Note that step 111 corresponds to the detecting portion.

In step 112, the CPU 18A controls the rear lateral camera 12 so as to change to a second exposure amount, at which there become images that are brighter than at the first exposure amount, and to so as to capture images, and the CPU 18A returns to step 104 and repeats the above-described processings. Due thereto, in the case of being instructed by a vehicle occupant, the captured images that are displayed on the monitor 14 become brighter, and the visibility can be improved.

In step 113, the CPU 18A judges whether or not a predetermined time period has elapsed, and stands-by until the predetermined time period has elapsed, and moves on to step 116. Note that, instead of judging whether or not a predetermined time period has elapsed, it may be judged whether or not a stop operation has been carried out by a vehicle occupant. Or, it may be judged whether or not a predetermined time period has elapsed or whether or not a stop operation has been carried out.

In step 116, the CPU 18A controls the rear lateral camera 12 so as to change to the first exposure amount and so as to capture images, and returns to step 104 and repeats the above-described processings.

By carrying out control in this way, in a case in which it is desired to brighten the displayed images, the captured images that are displayed on the monitor 14 can be brightened due to a vehicle occupant carrying out a predetermined operation such as a switch operation or the like. Therefore, the visibility improves and the safety can be improved.

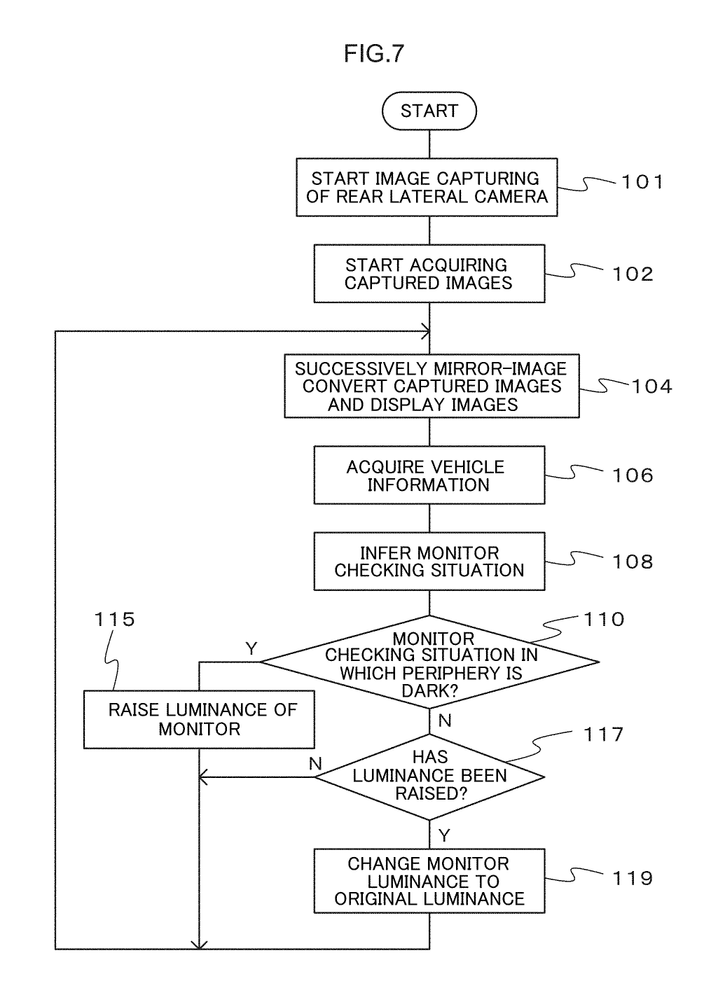

A second modified example of processings, which are carried out by the control device 18 of the viewing device 10 for a vehicle relating to the present embodiment, are described next. FIG. 7 is a flowchart showing a second modified example of the flow of processings that are carried out at the control device 18 of the viewing device 10 for a vehicle relating to the present embodiment. Note that description is given in which the processings of FIG. 7 start in a case in which an unillustrated ignition switch is turned on. Further, the processings of FIG. 7 are carried out due to the CPU 18A expanding, in the RAM 18C, and executing the control program for the displaying of an image for viewing that is stored in the ROM 18B. Further, FIG. 7 describes an example in which the brightness of the image that is displayed on the monitor 14 is adjusted by adjusting the luminance of the monitor 14. Further, processings that are the same as processings of FIG. 5 are described by using the same reference numbers.

First, in step 101, the CPU 18A controls the rear lateral camera 12 so as to start image capturing of the rear lateral camera 12, and moves on to step 102.

In step 102, the CPU 18A starts successively acquiring the captured images of the rear lateral camera 12, and moves on to step 104.

In step 104, the CPU 18A successively mirror-image converts the acquired captured images, and controls the monitor 14 so as to display the images on the monitor 14, and moves on to step 106. Due thereto, captured images of the vehicle rear lateral side are displayed on the monitor 14 as if on an optical mirror, and therefore, the vehicle rear lateral side can be viewed as the vehicle periphery.

In step 106, the CPU 18A acquires various types of vehicle information from the vehicle ECU 20, and moves on to step 108. Signals of the light switches, the illumination sensors, the shift position sensor, the vehicle speed sensor, the steering angle sensor, the turn lamp switches, the ignition switch (IG), the obstacle detecting sensors of the vehicle lateral sides, and the like are acquired as the acquired vehicle information.

In step 108, the CPU 18A infers a monitor checking situation, and moves on to step 110. The inferring of a monitor checking situation here is the inferring of a situation in which the vehicle periphery is dark and the vehicle periphery must be viewed. For example, in a case in which a light switch is on, or in a case in which illumination that is a predetermined illumination or lower is detected by an illumination sensor, it is inferred that there is a situation in which the vehicle periphery is dark. Further, in a case in which reversing is detected by the shift position sensor, it is inferred that there is a situation of reversing in which the vehicle periphery must be checked. Further, from the results of detection of the vehicle speed sensor, the steering angle sensor and the turn lamp switches, it is inferred that there is a situation in which the vehicle periphery must be checked such as turning or a lane change or the like. Further, in a case in which it is detected that the ignition switch is off, it is inferred that there is a situation in which the vehicle occupant has exited the vehicle wherein there is no need to check the vehicle periphery. Further, from the results of detection of the obstacle detecting sensor of a vehicle lateral side, it is inferred that there is a situation of the approach of an obstacle from the vehicle lateral side wherein there is the need to check the vehicle periphery.

In step 110, the CPU 18A judges whether or not there is a monitor checking situation in which the periphery is dark. If this judgment is affirmative, the CPU 18A moves on to step 115, and, if this judgment is negative, the CPU 18A moves on to step 117.

In step 115, the CPU 18A controls the monitor 14 so as to raise the luminance of the monitor 14, and returns to step 104 and repeats the above-described processings. Due thereto, the captured images that are displayed on the monitor 14 can be made to be brighter. Note that the luminance of the monitor 14 up until the raising of the luminance can be made to be a predetermined luminance that corresponds to the naked eye. Further, a predetermined amount of raising can be used as the amount of raising of the luminance. Further, the monitor 14 whose luminance is to be raised may be made to be only one of the two left and right monitors 14. For example, in a situation such as turning or a lane change or the approach of an obstacle or the like, it suffices to raise the luminance of the monitor 14 of only the respectively corresponding direction.

On the other hand, in step 117, the CPU 18A judges whether or not the luminance is currently raised. Namely, the CPU 18A judges whether or not there is a state in which the luminance of the monitor 14 was raised in step 115. If this judgment is affirmative, the CPU 18A moves on to step 119. If this judgment is negative, the CPU 18A returns to step 104 and repeats the above-described processings.

In step 119, the CPU 18A changes the luminance of the monitor 14 to the original luminance, and returns to step 104 and repeats the above-described processings.

By carrying out control in this way, in a situation in which the vehicle periphery is dark, such as at night or the like, and there is the need to check the vehicle periphery, the captured images that are displayed on the monitor 14 are brightened by adjusting the luminance of the monitor 14, and therefore, the visibility improves and the safety can be improved.

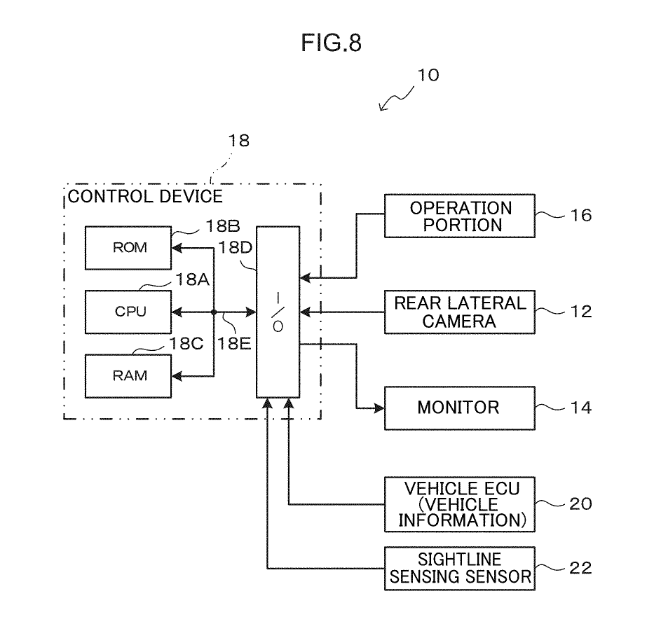

A modified example of the viewing device for a vehicle relating to the present embodiment is described next. FIG. 8 is a drawing showing the structure of the control system of the viewing device for a vehicle of the modified example.

In the above-described embodiment, a monitor checking situation in which the vehicle periphery is dark is inferred on the basis of vehicle information, and control is carried out such that the captured images displayed on the monitor 14 become brighter. However, in the modified example, the method of detecting the condition for brightening the captured images that are displayed on the monitor 14 is different. In the modified example, it is detected that the vehicle periphery is dark on the basis of vehicle information, and, in a case in which a situation in which the monitor 14 is being checked is detected by detecting the gazing of a vehicle occupant 14 on the monitor 14 for a predetermined time period, control is carried out such that the captured images that are displayed on the monitor 14 become brighter.

Namely, as shown in FIG. 8, a sightline sensing sensor 22 is further provided in the above-described embodiment, and is connected to the I/O 18D. Note that, because other structures are the same as those of the above-described embodiment, detailed description thereof is omitted.

The sightline sensing sensor 22 captures images of the vehicle occupant by a camera or the like for example, and senses the sightline of the vehicle occupant, and outputs the results of sensing to the control device 18. Due thereto, the control device 18 can detect that the vehicle occupant is gazing on the monitor 14.

Further, in a situation in which the vehicle occupant is gazing on the monitor 14 for a predetermined time period or more, there is the possibility that the vehicle periphery must be viewed. Therefore, in the modified example, the control device 18 detects, from the results of sensing of the sightline sensing sensor 22, a predetermined situation in which the monitor 14 must be checked. Note that the sightline sensing sensor 22 and the control device 18 correspond to the sightline sensing section.

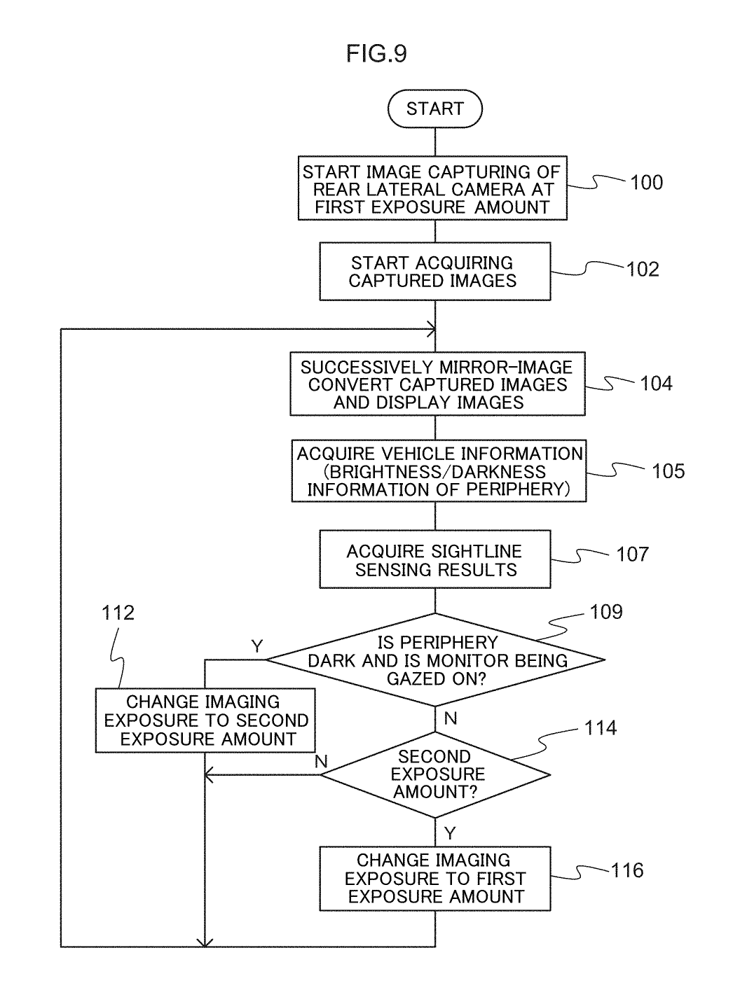

Next, concrete processings, which are carried out by the control device 18 of the viewing device 10 for a vehicle of the modified example that is structured as described above, are described next. FIG. 9 is a flowchart showing an example of the flow of processings that are carried out at the control device 18 of the viewing device 10 for a vehicle of the modified example. Note that description is given in which the processings of FIG. 9 start in a case in which an unillustrated ignition switch is turned on. Further, the processings of FIG. 9 are carried out due to the CPU 18A expanding, in the RAM 18C, and executing the control program for the displaying of an image for viewing that is stored in the ROM 18B. Further, FIG. 9 describes an example in which the brightness of the image that is displayed on the monitor 14 is adjusted by adjusting the exposure at the time of image capturing by the rear lateral camera 12. Further, processings that are the same as processings of FIG. 5 are described by using the same reference numbers.

First, in step 100, the CPU 18A controls the rear lateral camera 12 such that image capturing of the rear lateral camera 12 is started at a first exposure amount, and moves on to step 102. The first exposure amount is a predetermined exposure amount that is such that the captured image that is displayed on the monitor 14 is a brightness corresponding to the naked eye, and at least one of the shutter speed, the aperture and the gain is adjusted.

In step 102, the CPU 18A starts successively acquiring the captured images of the rear lateral camera 12, and moves on to step 104.

In step 104, the CPU 18A successively mirror-image converts the acquired captured images, and controls the monitor 14 so as to display the images on the monitor 14, and moves on to step 105. Due thereto, captured images of the vehicle rear lateral side are displayed on the monitor 14 as if on an optical mirror, and therefore, the vehicle rear lateral side can be viewed as the vehicle periphery.

In step 105, the CPU 18A acquires various types of vehicle information from the vehicle ECU 20, and moves on to step 107. In the modified example, information relating to the brightness/darkness of the vehicle periphery is acquired as the acquired vehicle information. For example, signals of the light switches, the illumination sensors or the like are acquired as second vehicle information that expresses that the vehicle periphery is dark.

In step 107, the CPU 18A acquires the results of sightline sensing from the sightline sensing sensor 22, and moves on to step 109.

In step 109, the CPU 18A judges whether or not the periphery is dark and the vehicle occupant is gazing on the monitor 14. In this judgment, it is judged, from the acquired vehicle information, whether or not the vehicle periphery is dark, and it is judged, from the results of sensing of the sightline sensing sensor 22, whether or not the vehicle occupant is gazing on the monitor 14 for a predetermined time period or more. If these judgments are both affirmative, the CPU 18A moves on to step 112, and, if at least one is negative, the CPU 18A moves on to step 114.

In step 112, the CPU 18A controls the rear lateral camera 12 so as to change to a second exposure amount, at which there become images that are brighter than at the first exposure amount, and so as to capture images, and the CPU 18A moves on to step 114. Due thereto, in the case of a monitor checking situation in which the periphery is dark, the captured images that are displayed on the monitor 14 become brighter, and the visibility in a situation in which the vehicle periphery is dark and the vehicle periphery must be checked can be improved. Note that the rear lateral camera 12 whose exposure amount is changed may be only one of the two left and right rear lateral cameras 12. For example, in a situation such as turning or a lane change or the approach of an obstacle or the like, it suffices to adjust the exposure of the rear lateral camera 12 of only the respectively corresponding direction. Further, in step 112, instead of the exposure amount, the monitor luminance may be adjusted so as to become brighter. Or, the exposure amount and the monitor luminance may be adjusted such that there is an image that is brighter than before adjustment.

On the other hand, in step 114, the CPU 18A judges whether or not the exposure amount of the rear lateral camera 12 is the second exposure amount. Namely, the CPU 18A judges whether or not there is a state in which the exposure amount was changed from the first exposure amount to the second exposure amount in step 112. If this judgment is affirmative, the CPU 18A moves on to step 116, and, if this judgment is negative, the CPU 18A returns to step 104 and repeats the above-described processings.

In step 116, the CPU 18A controls the rear lateral camera 12 so as to change to the first exposure amount and capture images, and returns to step 104 and repeats the above-described processings.

By carrying out control in this way, in a case in which the vehicle periphery is dark, such as at night or the like, and the vehicle occupant is gazing on the monitor 14, the captured images that are displayed on the monitor 14 are brightened, and therefore, the visibility improves and the safety can be improved.

Note that the above-described embodiment and modified example describe examples in which adjustment is carried out such that the captured images that are displayed on the monitor 14 become brighter by adjusting the exposure of the rear lateral camera 12 or the luminance of the monitor 14, but the present invention is not limited to this. Exposure adjustment of the rear lateral camera 12 and luminance adjustment of the monitor 14 may both be adjusted.

Further, in the above-described embodiment and modified example, description is given in which separate processings are carried out respectively when the condition for brightening the captured images that are displayed on the monitor 14 is a case of a monitor checking situation in which the vehicle periphery is dark, and when this condition is a case in which an instruction operation for adjusting the brightness of the images is carried out. However, the present invention is not limited to this. In either case, there may be a form that brightens the captured images that are displayed on the monitor 14.

Further, the above embodiment and modified example describe, as an example, a viewing device for a vehicle in which images of the vehicle rear lateral sides, which serve as the vehicle periphery, are captured and viewed. However, the present invention is not limited to this. For example, a viewing device for a vehicle that captures and displays images of the vehicle lateral sides or other directions such as the front, the rear or the like, may be applied.

Further, description has been given in which the processings that are carried out by the control device 18 in the above embodiment and modified example are software processings, but the present invention is not limited to this. For example, the processings may be processings that are carried out by hardware, or may be processings that combine both hardware and software.

Further, the processings that are carried out by the control device 18 in the above-described embodiment and modified example may be stored as a program on a storage medium and distributed.

Moreover, the present invention is not limited to the above, and, other than the above, can of course be implemented by being modified in various ways within a scope that does not depart from the gist thereof.

The disclosure of Japanese Patent Application No. 2016-095456 that was filed on May 11, 2016 is, in its entirety, incorporated by reference into the present specification.

1. A viewing device for a vehicle, comprising:
an imaging portion that captures images of a vehicle periphery;
a display portion that displays captured images that are captured by the imaging portion; and
an adjusting section that, in a case in which predetermined first vehicle information, which expresses a predetermined situation in which a vehicle occupant must check the display portion, is detected, and predetermined second vehicle information that expresses that the vehicle periphery is dark is detected, or in a case in which a predetermined operation is detected by a detecting portion that detects the predetermined operation, adjusts at least one of exposure at a time of image capturing by the imaging portion or display luminance of the display portion, such that the captured images that are displayed on the display portion become brighter,
wherein the first vehicle information is results of detection of a sightline detecting portion that detects that a vehicle occupant is gazing on the display portion for a predetermined time period or more.

2.-6. (canceled)

7. A viewing device for a vehicle, comprising:
an imaging portion that captures images of a vehicle periphery;
a display portion that displays captured images that are captured by the imaging portion; and
an adjusting section that, in a case in which predetermined first vehicle information, which expresses a predetermined situation in which a vehicle occupant must check the display portion, is detected and predetermined second vehicle information that expresses that the vehicle periphery is dark is detected, or in a case in which a predetermined operation is detected by a detecting portion that detects the predetermined operation, adjusts at least one of exposure at a time of image capturing by the imaging portion or display luminance of the display portion, such that the captured images that are displayed on the display portion become brighter,
wherein the imaging portion captures images of a vehicle rear lateral side or a vehicle rear side, and
the first vehicle information is vehicle information expressing a situation of exiting of a vehicle occupant from a vehicle.

8. A viewing device for a vehicle, comprising:
an imaging portion that captures images of a vehicle periphery;
a display portion that displays captured images that are captured by the imaging portion; and
an adjusting section that, in a case in which predetermined first vehicle information, which expresses a predetermined situation in which a vehicle occupant must check the display portion, is detected and predetermined second vehicle information that expresses that the vehicle periphery is dark is detected, or in a case in which a predetermined operation is detected by a detecting portion that detects the predetermined operation, adjusts at least one of exposure at a time of image capturing by the imaging portion or display luminance of the display portion, such that the captured images that are displayed on the display portion become brighter,
wherein the imaging portion captures images of a vehicle rear lateral side or a vehicle rear side, and
the first vehicle information is vehicle information expressing at least one situation among reversing, turning, a lane change, and approach of an obstacle.

9. The viewing device for a vehicle of any one of claim 1, wherein the second vehicle information is lighting information of at least one of headlights or vehicle side lights.

10. The viewing device for a vehicle of any one of claim 7, wherein the second vehicle information is lighting information of at least one of headlights or vehicle side lights.

11. The viewing device for a vehicle of any one of claim 8, wherein the second vehicle information is lighting information of at least one of headlights or vehicle side lights.

12. The viewing device for a vehicle of any one of claim 1, wherein, in a case in which the first vehicle information is detected, or in a case in which the predetermined operation is detected, the adjusting section adjusts at least one of the exposure or the display luminance such that the captured images that are displayed on the display portion become brighter from a predetermined brightness that corresponds to the naked eye.

13. The viewing device for a vehicle of any one of claim 7, wherein, in a case in which the first vehicle information is detected, or in a case in which the predetermined operation is detected, the adjusting section adjusts at least one of the exposure or the display luminance such that the captured images that are displayed on the display portion become brighter from a predetermined brightness that corresponds to the naked eye.

14. The viewing device for a vehicle of any one of claim 8, wherein, in a case in which the first vehicle information is detected, or in a case in which the predetermined operation is detected, the adjusting section adjusts at least one of the exposure or the display luminance such that the captured images that are displayed on the display portion become brighter from a predetermined brightness that corresponds to the naked eye.
